(19) United States
(12) Patent Application Publication
(10) Pub. No.: US 2025/0291475 A1
(43) Pub. Date: Sep. 18, 2025

(54) TOUCH APPARATUS WITH LOW LATENCY INTERACTIONS

(71) Applicant: FlatFrog Laboratories AB, Lund (SE)

(72) Inventors: Markus Andreasson, Lund (SE); Gunnar Weibull, Malmö (SE)

(21) Appl. No.: 19/183,636

(22) Filed: Apr. 18, 2025

Related U.S. Application Data
(63) Continuation of application No. 17/760,139, filed on Aug. 4, 2022, now Pat. No. 12,282,653.

(30) Foreign Application Priority Data
Feb. 8, 2020 (SE) 2030041-4

(51) Int. Cl. G06F 3/04883; G06F 9/54

(52) U.S. Cl. CPC G06F 3/04883; G06F 9/54

(57) ABSTRACT

An interactive device is described that is configured to: display an output of a remote device, wherein an output delay exists between the output being generated by the remote device and the output being displayed on the interactive device, generate an interaction data in dependence on an interaction with the interactive device at a location, transmit the interaction data to the remote device, display an updated output of the remote device, the updated output being generated by the remote device subsequent to receiving the interaction data, wherein the interactive device being further configured to: generate an interaction image of an area of the updated output of the remote device corresponding to the location of the interaction, determine an interaction indication in dependence on the interaction image, displaying an interaction indication on the interactive device at a location of one or more further interactions with the interactive device.

### BACKGROUND OF THE INVENTION

### Field of the Invention

The present invention relates to an improved touch experience on touch surfaces of touch-sensitive apparatus. In particular, the present invention relates to providing low latency touch interactions for interactions with high latency systems.

### Description of the Related Art

Touch-sensitive systems (“touch systems”) are in widespread use in a variety of applications. Typically, the touch systems are configured to detect a touching object such as a finger or stylus, either in direct contact, or through proximity (i.e. without contact), with a touch surface. Touch systems may be used as touch pads in laptop computers, equipment control panels, and as overlays on displays e.g. hand held devices, such as mobile telephones. A touch panel that is overlaid on or integrated in a display is also denoted a “touch screen”. Many other applications are known in the art.

There are numerous known techniques for providing touch sensitivity, e.g. by incorporating resistive wire grids, capacitive sensors, strain gauges, etc. into a touch panel. There are also various types of optical touch systems, which e.g. detect attenuation of emitted light by touch objects on or proximal to a touch surface.

One specific type of optical touch system uses projection measurements of light that propagates on a plurality of propagation paths inside a light transmissive panel. The projection measurements thus quantify a property, e.g. power, of the light on the individual propagation paths, when the light has passed the panel. For touch detection, the projection measurements may be processed by simple triangulation, or by more advanced image reconstruction techniques that generate a two-dimensional distribution of disturbances on the touch surface, i.e. an “image” of everything on the touch surface that affects the measured property. The light propagates by total internal reflection (TIR) inside the panel such that a touching object causes the propagating light on one or more propagation paths to be attenuated by so-called frustrated total internal reflection (FTIR). Hence, this type of system is an FTIR-based projection-type touch system. Examples of such touch systems are found in U.S. Pat. Nos. 3,673,327, 4,254,333, 6,972,753, US2004/0252091 US2006/0114237, US2007/0075648, W02009/048365, US2009/0153519, US2017/0344185, WO2010/006882, WO20 10/064983, and WO2010/134865.

Another category of touch sensitive apparatus is known as projected capacitive (“p-cap”). A set of electrodes are spatially separated in two layers usually arranged in rows and columns. A controller scans and measures the capacitance at each row and column electrode intersection. The intersection of each row and column produces a unique touch-coordinate pair and the controller measures each intersection individually. An object that touches the touch surface will modify the capacitance at a row and column electrode intersection. The controller detects the change in capacitance to determine the location of the object touching the screen.

In another category of touch-sensitive apparatus known as ‘above surface optical touch systems’, a set of optical emitters are arranged around the periphery of a touch surface to emit light that travels above the touch surface. A set of light detectors are also arranged around the periphery of the touch surface to receive light from the set of emitters from above the touch surface. An object that touches the touch surface will attenuate the light on one or more propagation paths of the light and cause a change in the light received by one or more of the detectors. The location (coordinates), shape or area of the object may be determined by analysing the received light at the detectors. Examples of such touch systems are found in e.g. PCT/SE2017/051233 and PCT/EP2018/052757.

When using a touch-sensing apparatus to interact with a system that is remote from the touch-sensing apparatus, significant latency can be introduced. For example, interacting with a remotely shared desktop on a remote system using a local touch sensitive display can result in significant latency between the physical interaction on the local touch sensitive display and the visual indication of the interaction. This may be due to the significant round trip time for: the local touch sensitive display to encode and transmit the interaction to the remote system, the remote system to process the interaction and update the output of the remote system (e.g. the shared desktop), and for the updated output of the remote system to be transmitted back to the local touch sensitive display. Latency of greater than 50 ms is not unexpected and can provide a disruptive and unsatisfying experience to a user attempting to interact with the local touch sensitive display. For certain types of interaction, such as writing or drawing using a pen, latency sensitivity is even higher, and latency greater than 50 ms can make the experience ineffective.

Various known techniques have been adopted to reduce touch system latency in a local system. For example, a touch-sensitive apparatus can be configured to increase the scan rate of the touch-sensing apparatus or to use faster processors to carry out the touch decoding faster or the touch signal post processing in a shorter time. Host control devices can be configured so that the operating system does not introduce delays in transmitting signal input to application software. The operating systems can be further configured to avoid buffering. However, these solutions cannot be used for reducing round trip latency of sending an interaction data to a remote system and receiving and displaying the resulting interaction on the local system.

### SUMMARY OF THE INVENTION

Embodiments of the present invention aim to address the aforementioned problems.

According to an aspect of the present description, there is provided an interactive device configured to: display an output of a remote device, wherein an output delay exists between the output being generated by the remote device and the output being displayed on the interactive device, generate an interaction data in dependence on an interaction with the interactive device at a location, transmit the interaction data to the remote device, display an updated output of the remote device, the updated output being generated by the remote device subsequent to receiving the interaction data, wherein the interactive device being further configured to: generate an interaction image of an area of the updated output of the remote device corresponding to the location of the interaction, determine an interaction indication in dependence on the interaction image, displaying an interaction indication on the interactive device at a location of one or more further interactions with the interactive device. The interactive device may comprise a touch surface and the interaction comprises a touch interaction at a location on the touch surface. The interactive device may comprise a device display configured to display the output of a remote device. The interactive device may comprise a touch display and the interaction comprises a touch interaction at a location on the touch display. The interactive device may be connected to the remote device over a network. The output delay may be equal to or greater than 50 ms. The present aspect may be particularly advantageous where the output delay is equal to or greater than 100 ms. The output of the remote device may be a streamed video of an interactive software. The interaction data transmitted to the remote device is used to update an interactive software on the remote device. The interaction image may comprise a set of pixels corresponding to pixels of the updated output within a radius of the location of the interaction.

Optionally, the determination of the interaction indication further comprises: generating a pre-interaction image of an area of the output of the remote device corresponding to the location of the interaction, generating an interaction image of an area of the updated output of the remote device corresponding to the location of the interaction, determining an interaction indication in dependence on the pre-interaction image and interaction image. The pre-interaction image may comprise a set of pixels corresponding to pixels of the output of the remote device within a radius of the location of the interaction. The interaction indication may be generated in dependence on a difference between the pre-interaction image and the interaction image. Displaying an interaction indication on the interactive device at a location of one or more further interactions may comprise displaying the interaction indication on the interactive device at a position corresponding to the one or more further interactions before the corresponding interactions are displayed in the updated output. A transmission delay may exist between the interaction data being transmitted by the interactive device and received by the remote device, and wherein the output being displayed on the interactive device further comprising only displaying the interaction indication on the interactive device at a location of one or more further interactions for a period corresponding to the output delay and the transmission delay.

According to another aspect of the present description, there is provided a method for interaction between an interactive device and a remote device comprising: displaying an output of a remote device on the interactive device, wherein an output delay exists between an output being generated by the remote device and the output being displayed on the interactive device, generating an interaction data in dependence on an interaction with the interactive device at a location, transmitting the interaction data to the remote device, displaying an updated output of the remote device, the updated output being generated by the remote device subsequent to receiving the interaction data, wherein the method further comprising the steps of: generating an interaction image of an area of the updated output of the remote device corresponding to the location of the interaction, determining an interaction indication in dependence on the interaction image, displaying an interaction indication on the interactive device at a location of one or more further interactions with the interactive device.

### BRIEF DESCRIPTION OF THE DRAWINGS

FIG. 1a shows a system drawing of an embodiment of the disclosure;

FIG. 1b shows a system drawing of another embodiment of the disclosure;

FIG. 1c shows a system drawing of another embodiment of the disclosure;

FIG. 2 shows a sequence diagram of an embodiment of the disclosure;

FIG. 3 shows a sequence diagram of another embodiment of the disclosure;

FIG. 4a-f shows a time sequence of an embodiment of the disclosure.

### DETAILED DESCRIPTION OF THE PREFERRED EMBODIMENT

Various other aspects and further embodiments are also described in the following detailed description and in the attached claims with reference to the accompanying drawings, in which:

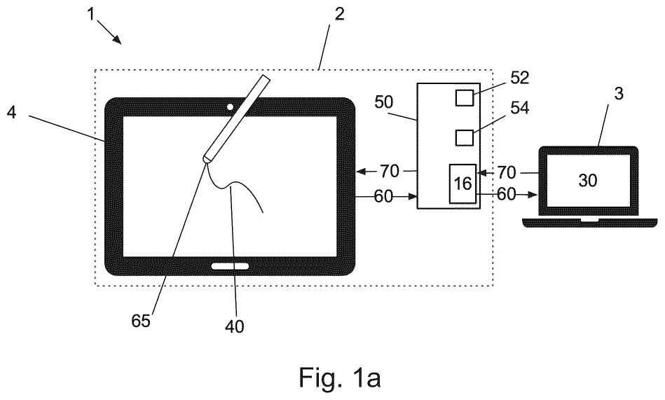

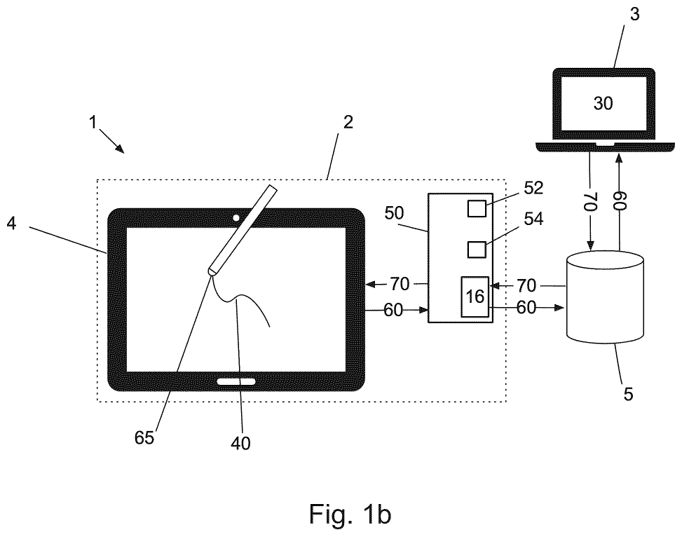

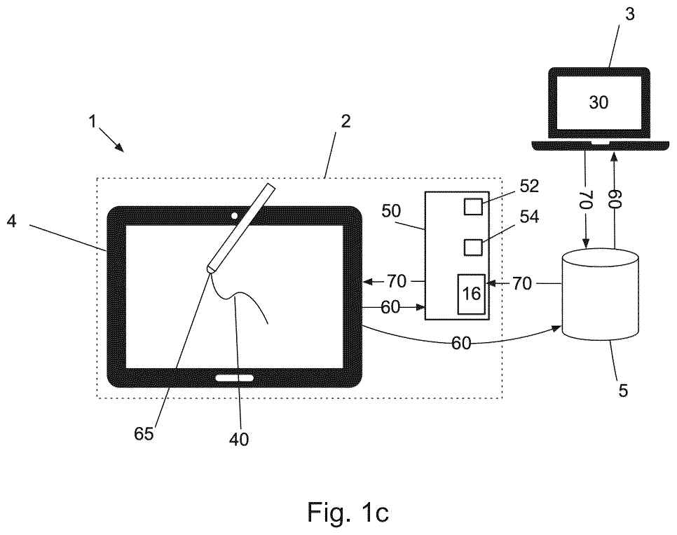

FIG. 1a is an example configuration of an interaction system 1 comprising a processing device 50 for providing an interface between an interactive device 2 and an remote device 3. In this example, interactive device 2 is integrated with the processing device 50. The processing device 50 comprises a processor 52, a memory 54, and interface 16. Processing device 50 is configured to execute a software stored in memory 54 and display to touch display 4 an output 70 as video data. Processing device 50 is further configured to receive interaction data 60 (e.g. touch co-ordinate data) from touch display 4 wherein interaction data 60 corresponds to touch interactions occurring on the touch surface of touch display 4. In one embodiment, the software running on processor 52 is a software 88 configured to receive and process interaction data 60 and transmit interaction data 60 to remote device 3 via interface 16. Software 88 may also be configured to receive remote device output 70 via interface 16 and display output 70 on touch display 4.

The output 70 of the remote device 3 may be a streamed video of a remote interactive software 98. The interaction data 60 is used to update an interactive software 98 on the remote device 3. The interaction data 60 transmitted to the remote device 3 need not be touch coordinates. In some embodiments, the interaction data 60 may comprise a mouse position or any other former of two-dimensional or three-dimensional spatial control data, such as a VR controller or joystick control. In an example where the interaction data 60 is touch coordinate data, a user can interact with remote device 3 via interactive device 2 and touch display 4. For example, when showing a presentation from the remote device 3 on the interactive device 2, the user can interact with remote device 3 using touch display 4.

The interactive device 2 may be connected to the remote device 3 over a network using interface 16. In this embodiment, interface 16 may comprise a Ethernet, Wi-Fi, Fibre Channel or equivalent network interface. The network between interactive device 2 and remote device 3 may comprise a local area network (LAN), the internet, or equivalent, and may introduce transmission latency. Similarly, other aspects of the interactive device 2 and remote device 3 may introduce latency of the interaction experience, such as video encoding time and other processing tasks.

In one embodiment in which an interaction 99 occurs at a location 93 on the touch display 4 and the corresponding interaction data 60 is transmitted to remote device 3, an interaction indication may be displayed on touch display 4 at the location 93 of the interaction 99 before the updated output 70b of remote device 3 is received at interactive device 2. This allows a user of interactive device 2 to see immediate feedback from their interaction 99 before the remote device 3 has been able to process the interaction and send back the updated output 70b. An example of such an interaction indication may be a cursor at the location 93 of the interaction 99 or a trail that follows the location of the interaction for a period of time. One disadvantage of this approach is that the interaction indication will not necessarily visually match the results of the interaction on remote device 3. Therefore, although the user can see a low latency indication of the interaction location, they will be unable to obtain an accurate indication of the actual output of the interaction. They will only be able to see the true results of the interaction once the updated output from remote device 3 is received and shown in touch display 4. An embodiment of the description provides a solution to the above problem. In order to generate a visually more accurate predictive interaction indication 230, an embodiment provides a technique for imaging the true interaction from remote device 3 and generating a predictive interaction indicator 230 for indicating further interactions 215 to the user with low latency.

FIG. 1b is another configuration of interaction system 1 comprising networked device 5 connected to interactive device 2 and remote device 3. In this example, interface 16 may be connected to networked device 5 via at least one of an ethernet connection, a Wi-Fi connect, USB, Thunderbolt, or equivalent for transmitting interaction data 60 and HDMI, Thunderbolt, USB-C, or equivalent, for transmitting remote device output 70. Networked device 5 may then be connected to remote device 3 via a Local Area Network, the Internet, or equivalent. In one embodiment, interactive device 2 is configured to operate Android™ operating system or equivalent on processing device 50 and the software 88 is an Android™ application or equivalent configured to receive and process interaction data 60 and transmit interaction data 60 to Networked device 5 via interface 16. Networked device 5 may then transmit interaction data 60 to remote device 3. Networked device 5 may then receive remote device output 70 from remote device 3 and transmit remote device output 70 to interactive device 2 for processing by software 88. Remote device 3 may connect to networked device 5 by means of a Miracast standard or equivalent. In an embodiment shown in FIG. 1c, touch data is simultaneously transmitted from touch display 4 to processing device 50 and networked device 5.

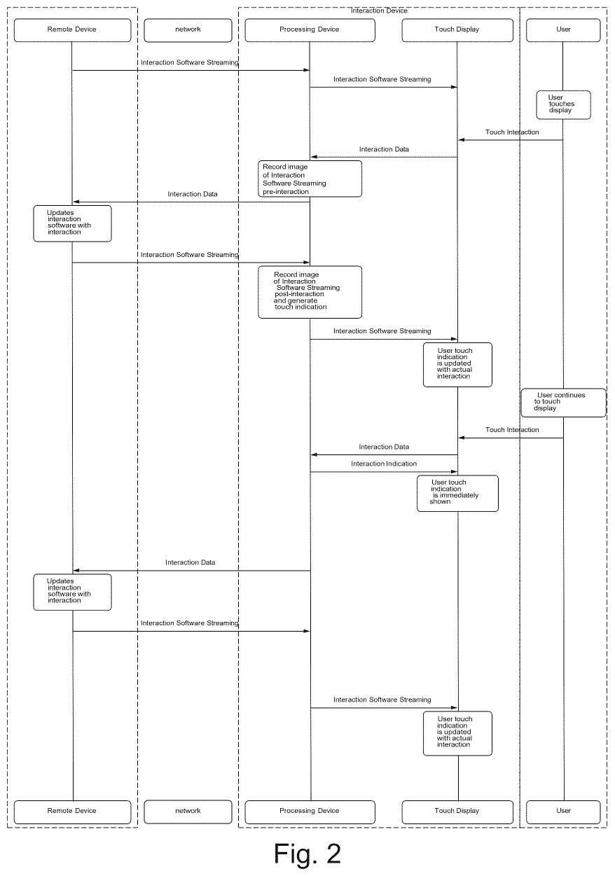

FIG. 2 shows an example of the embodiment of FIG. 1a. The sequence diagram of the FIG. 2 describes the following sequence:
Remote device 3 transmits a streaming video of an interaction software 98 running on remote device 3. The streaming video is transmitted via a network to interaction device 2, wherein it is received at processing device 50 and displayed on touch display 4.
A user interacts with touch display 4 to indicate an intended interaction with the interaction software 98 running on remote device 3. The touch interaction 94 is detected at touch display 4 and processed by processing device 50 as touch interaction data 60 before being transmitted (with a likely delay) to remote device 3 over the network.
In an optional step, at a time before, approximately in parallel, or within a period less than the interaction latency of the present system (i.e. the delay in sending interactions to remote device 3 and receiving the resulting update from remote device 3) of the above step, the processing device 50 images an area 210 of the streaming video corresponding to the location 93 of the touch interaction 94.
The remote device 3 receives the touch interaction data 60 and updates the interaction software 98 using the touch interaction data 60. The remote device 3 then transmits the updated output 70b of the interaction software 98 back to interaction device 2 via the network with a delay.
The updated output 70b of the interaction software 98 is received by processing device 50. Processing device 50 images an area 210 of the updated output 70b of the interaction software 98 corresponding to the location 93 of the touch interaction 94.
The updated output 70b of the interaction software 98 is displayed on touch display 4.
The processing device 50 generates a predictive interaction indication 230 in dependence on the image of the area 210 of the updated output 70b of the interaction software 98 and, optionally also on the image of the area 210 of the streaming video before the update. The predictive interaction indication 230 may be a particular brush shape, cursor type, colour, object selection visualisation, or objects dragging or resizing visualisation, as well as any other type of interaction indication that can be rendered.
The user further interacts with touch display 4 to indicate a further intended interaction with the interaction software 98 running on remote device 3. The touch interaction is detected at touch display 4 and processed by processing device 50 as touch interaction data.
The touch interaction data is transmitted to remote device 3 over the network.
At a time before, approximately in parallel, or within a period less than the interaction latency of the present system of the above step, interaction device 2 displays the generated predictive interaction indication 230 at a location corresponding to the further interaction 215. This appears as a low latency interaction to the user.
The remote device 3 receives the further touch interaction data and updates the interaction software using the touch interaction data. The remote device 3 then transmits the further updated output of the interaction software back to interaction device 2 via the network.
The updated output of the interaction software is received by processing device 50 and displayed on touch display 4, replacing the predictive interaction indication 230 at the same location.

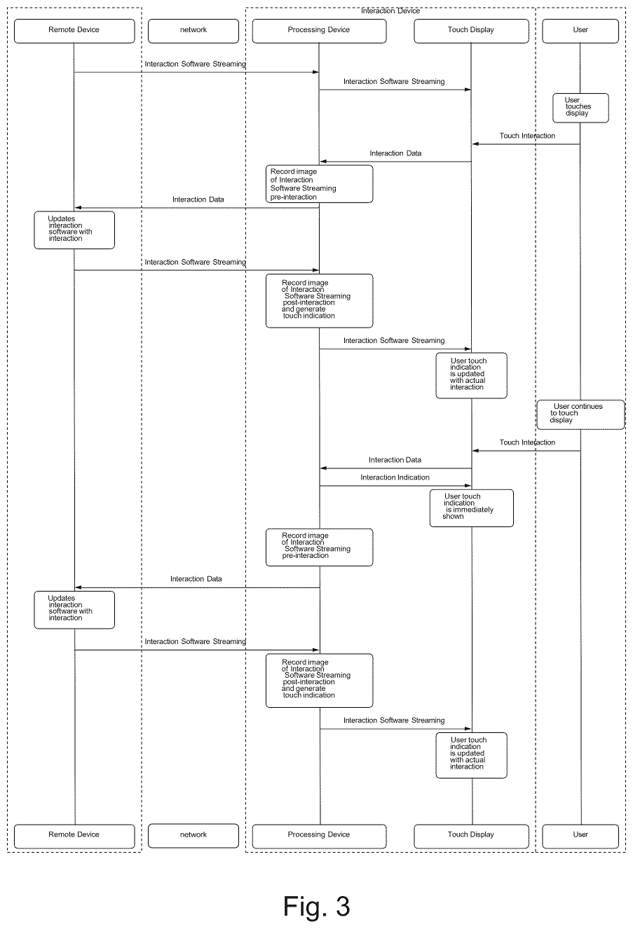

FIG. 3 shows a further example with a different approach to updating the predictive interaction indicator 230. In the example of FIG. 2, the predictive interaction indicator 230 is generated at the start of an interaction and remains the same throughout the interaction. In the example of FIG. 3, the interaction indicator is continually updated throughout the interaction to match the true interaction occurring on the interaction software. This may be advantageous where the interaction is more dynamic, rather than a fixed colour, brush shape, or cursor shape.

In one embodiment, area 210 may be the entire application window in which the interaction occurs. For example, if the user interacts within a word processing application window, the processing device 50 may identify the word processing application based on an image of the entire application window and determine a suitable low latency predictive interaction indicator 230 for use with the word processing application until the true interaction is received from remote device 3. E.g. a particular cursor may be used corresponding to the cursor normally used by the word processing application. In one embodiment, area 210 may be the entire display of output 70. The processing device 50 may then determine a suitable low latency predictive interaction indicator 230 in dependence on the context provided by the entire display of output 70.

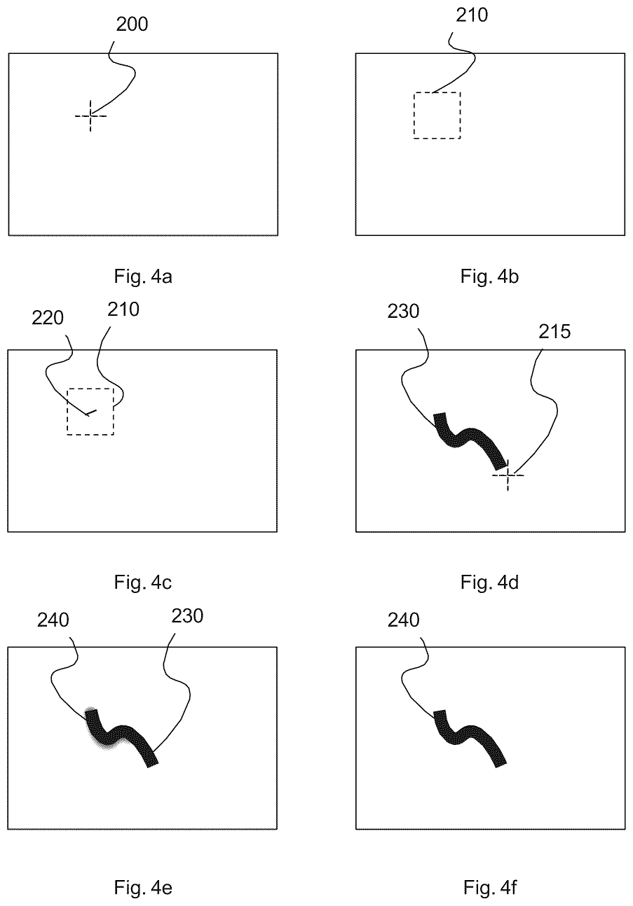

FIG. 4 shows a further example with more details on the process of generating an interaction indicator. As shown in FIG. 4a, the user interacts with touch display 4 to indicate an intended interaction with the interaction software 98 running on remote device 3. The touch interaction 94 is detected at touch display 4 at interaction location 200 and transmitted to remote device 3 over the network.

At a time before, approximately in parallel, or within a period less than the interaction latency of the present system of the above step, the processing device 50 images an area 210 of the streaming video corresponding to the interaction location 200 of the touch interaction 94 to form an interaction image 97. The interaction image 97 may comprise a set of pixels 211 corresponding to pixels within a radius of the location 93 of the touch interaction 94. The set of pixels 211 may be a circle with the centre corresponding to the position of the interaction location 200. In this example, the radius of the circle may be between 1 and 30 pixels, but larger sizes circles may also be envisaged. Alternatively, as shown in FIG. 4b, the set of pixels 211 may be a square with the centre corresponding to the interaction location 200. Other shapes may also be envisaged.

As shown in FIG. 4c, the updated output 70b of the remote interaction software 98 is displayed on touch display 4 a period of time after the events of FIG. 4a, showing the resulting interaction visualisation 220 of the user's interaction. The processing device 50 images an area 210 of the updated output 70b corresponding to the interaction location 200 of the touch interaction 94 to form an updated interaction image 97b. The size and shape of updated interaction image 97b may substantially correspond to the interaction image 97. For example, the set of pixels 211 may be a circle with the centre corresponding to the position of the interaction location 200. Alternatively, the set of pixels 211 may be a square with the centre corresponding to the position of the interaction location 200. Other shapes may also be envisaged.

The processing device 50 then generates a predictive interaction indication 230 for touch interaction 94 in dependence on the interaction image 97 and the updated interaction image 97b. In one embodiment, a difference is determined between the interaction image 97 and the updated interaction image 97b. The difference is indicative of the change in the pixels at the interaction location 200 of the interaction from before the interaction and after the interaction. The change in the pixels will show the interaction on the interaction software 98 resulting from touch interaction 94 and may be a good visual indicator for the low latency predictive interaction indicator 230. For example, after a touch interaction 94 occurs, a green dot may appear at the touch interaction location. It may be useful to assume that future interactions will also result in a green dot, and so the low latency predictive interaction indicator 230 can be set to a green dot, in order to provide a realistic but low latency local indication of the interaction with remote device 3. In one example embodiment, predictive interaction indication 230 may comprise a bitmap of all changed pixels between interaction image 97 and the updated interaction image 97b, with any unchanged pixels set to transparent or equivalent. In the previous example, this bitmap may comprise an area of green pixels surrounded by transparent pixels.

As shown in FIG. 4d, the user further interacts with touch display 4 and the touch interaction data is transmitted to remote device 3 over the network. At the same time, the predictive interaction indication 230 (e.g. the green dot of the earlier example) is displayed on touch display 4 at a location corresponding to the further interactions 215. This appears as a low latency interaction to the user.

As shown in FIG. 4e, the remote device 3 receives the further touch interaction data and updates the interaction software using the touch interaction data. The remote device 3 then transmits the further updated output of the interaction software 98 back to interaction device 2 via the network. As the updated output of the remote interaction software 98 is received by processing device 50 and displayed on touch display 4, interaction outcome 240 as processed by remote device 3 will be displayed on touch display 4 at their corresponding positions. The predictive interaction indications 230 at these positions becomes redundant and may be removed.

As shown in FIG. 4f, eventually the earlier interaction outcome 240 as processed by remote device 3 will be displayed on touch display 4 will completely replace the predictive interaction indications 230 on touch display 4.

In one embodiment, instead of determining predictive interaction indication 230 based on a comparison of pixels between the interaction image 97 and the updated interaction image 97b, predictive interaction indication 230 may instead be based on a predictive interaction indication 230 or interaction outcome 240 for a previous interaction. A previous interaction may be an interaction occurring on touch display 4 that is non-continuous with the new interaction, i.e., the user stopped interacting with touch display 4 before the new interaction began. In one embodiment, a predictive interaction indication 230 for a new interaction is set to the interaction outcome 240 of a previous interaction. Where the system is attempting to generate an accurate predictive interaction indication 230 for a new interaction, a good predictor of the interaction outcome 240 for the new interaction may be the interaction outcome 240 of a previous interaction that occurred within a period of time of the new interaction and/or in the vicinity of the new interaction. In one embodiment, a predictive interaction indication 230 for a new interaction may be set to the interaction outcome 240 of a previous interaction that occurred within the last 4000 ms, or more preferably within the last 1000 ms, of the new interaction. In one embodiment, a predictive interaction indication 230 for a new interaction may be set to the interaction outcome 240 of a previous interaction that occurred within a radius of 5 cm, or more preferably 2 cm, of the new interaction. In one embodiment, a predictive interaction indication 230 for a new interaction may be set to the interaction outcome 240 of a previous interaction that occurred within a radius of 5 cm, or more preferably 2 cm, of the new interaction. In one embodiment, a predictive interaction indication 230 for a new interaction may be set to the interaction outcome 240 of a previous interaction that occurred within a radius of 5 cm, or more preferably 2 cm, of the new interaction and within the last 4000 ms, or more preferably within the last 1000 ms, of the new interaction. In alternative embodiments to the described above, the predictive interaction indication 230 for the previous interaction is used instead of the interaction outcome 240 of the previous interaction. This may be required where interaction outcome 240 was e.g. never determined for the previous interaction.

In one embodiment, predictive interaction indication 230 may be based on a location of a previous interaction. In one example, where a previous interaction occurred at a location corresponding to a colour picking element, predictive interaction indication 230 is configured to match the colour corresponding to the colour picking element.

In one embodiment, a predictive interaction indication 230 is determined in dependence on the presence of a user interface (UI) element positioned under or proximal to the touch interaction 94. The UI element may comprise buttons, scrollbars, menu items, checkboxes, window resize interface, etc. In one embodiment, where a resize interface of a window (e.g. a peripheral edge of an application window) is located proximal to the starting point of touch interaction 94, predictive interaction indication 230 is a window size indicator (e.g. wireframe box or equivalent) showing the expected new size and/or position of the window in response to touch interaction 94. In this embodiment, interaction outcome 240 will show the window being resized with a delay relative to the window size indicator. In one embodiment where interaction outcome 240 shows no change in the window size, the window size indicator is no longer used for predictive interaction indication 230. In one embodiment where the UI element is an UI element with no expected visible interaction outcome 240, predictive interaction indication 230 is not used.

1.-16. (canceled)

17. An interactive device configured to:
display an output of a remote device, wherein an output delay exists between the output being generated by the remote device and the output being displayed on the interactive device,
generate an interaction data in dependence on an interaction with the interactive device at a location,
transmit the interaction data to the remote device, and
display an updated output of the remote device, the updated output being generated by the remote device subsequent to receiving the interaction data and in response to the interaction data,
wherein the interactive device being further configured to:
generate an interaction image of an area of the updated output of the remote device corresponding to the location of the interaction comprising imaging said area to record the interaction image,
determine a predictive interaction indication to display on the interactive device in dependence on the interaction image of the area of the updated output, wherein the predictive interaction indication comprises a brush shape and/or a brush colour, and
display the predictive interaction indication on the interactive device at a location of one or more further interactions with the interactive device before the one or more further interactions are received by the remote device and transmitted back to the interactive device by the remote device as updated output for display on the interactive device, wherein the displaying of the predictive interaction indication reduces an appearance of transmission delay between the remote device and the interactive device over a network.

18. The interactive device of claim 17 wherein the interactive device comprises a touch surface and the interaction comprises a touch interaction at a location on the touch surface.

19. The interactive device of claim 17, wherein the interactive device comprises a device display configured to display the output of a remote device.

20. The interactive device of claim 17, wherein the interactive device comprises a touch display and the interaction comprises a touch interaction at a location on the touch display.

21. The interactive device of claim 17, wherein the interactive device is connected to the remote device over a network.

22. The interactive device of claim 17, wherein the output delay is greater than 50 ms.

23. The interactive device of claim 17, wherein the output of the remote device is a streamed video of an interactive software.

24. The interactive device of claim 17, wherein the interaction data transmitted to the remote device is used to update an interactive software on the remote device.

25. The interactive device of claim 17, wherein the interaction image comprises a set of pixels corresponding to pixels of the updated output within a radius of the location of the interaction.

26. The interactive device of claim 17, wherein determination of the predictive interaction indication further comprises:
generating a pre-interaction image of an area of the output of the remote device corresponding to the location of the interaction,
generating the interaction image of the area of the updated output of the remote device corresponding to the location of the interaction, and
generating the predictive interaction indication in dependence on the pre-interaction image and the interaction image.

27. The interactive device of claim 17, wherein the pre-interaction image comprises a set of pixels corresponding to pixels of the output of the remote device within a radius of the location of the interaction.

28. The interactive device of claim 26, wherein the predictive interaction indication is generated in dependence on a difference between the pre-interaction image and the interaction image.

29. The interactive device of claim 17, wherein displaying a predictive interaction indication on the interactive device at a location of one or more further interactions comprises displaying the predictive interaction indication on the interactive device at a position corresponding to the one or more further interactions before corresponding interactions are displayed in the updated output.

30. The interactive device of claim 17, wherein a transmission delay exists between the interaction data being transmitted by the interactive device and received by the remote device, and wherein the output being displayed on the interactive device further comprising only displaying the predictive interaction indication on the interactive device at a location of one or more further interactions for a period corresponding to the output delay and the transmission delay.

31. The interactive device of claim 17, wherein only displaying predictive interaction indication on the interactive device at the location of the one or more further interactions where the updated output of the remote device does not yet show results of further interactions on interactive device.

32. A method for interaction between an interactive device and a remote device comprising:
displaying an output of a remote device on the interactive device, wherein an output delay exists between an output being generated by the remote device and the output being displayed on the interactive device,
generating an interaction data in dependence on an interaction with the interactive device at a location,
transmitting the interaction data to the remote device,
displaying an updated output of the remote device, the updated output being generated by the remote device subsequent to receiving the interaction data and in response to the interaction data,
generating an interaction image of an area of the updated output of the remote device corresponding to the location of the interaction comprising imaging said area to record the interaction image,
determining a predictive interaction indication to display on the interactive device in dependence on the interaction image corresponding to the remote device, wherein the predictive interaction indication comprises a brush shape and/or a brush colour, and
displaying the predictive interaction indication on the interactive device at a location of one or more further interactions with the interactive device before the one or more further interactions are received by the remote device and transmitted back to the interactive device by the remote device as updated output for display on the interactive device, wherein the display of the predictive interaction indication reduces an appearance of transmission delay between the remote device and the interactive device over a network.
